(19) United States
(12) Patent Application Publication
(10) Pub. No.: US 2007/0053595 A1
(43) Pub. Date: Mar. 8, 2007

(54) Multi-resolution signal decomposition level selection

(75) Inventor: Lalitha M. Eswara, Bangalore (IN)

Correspondence Address: SCHWEGMAN, LUNDBERG, WOESSNER & KLUTH, P.A., P.O. BOX 2938, MINNEAPOLIS, MN, 55402, US

(73) Assignee: Honeywell International Inc.

(21) Appl. No.: 11/222,176

(22) Filed: Sep. 8, 2005

(51) Int. Cl. G06K 9/36

(52) U.S. Cl. 382/233

(57) ABSTRACT

Multi-resolution Signal Decomposition (MSD) levels for wavelet decomposition are determined automatically in real time. At each level of decomposition, local high frequency variations are eliminated or processed, while gradual patterns present in process control data are considered for further levels of decomposition. These wavelet coefficients are the approximate coefficients, are used for determining the suitable level of MSD. This invention utilizes signal-characterizing properties of these approximate coefficients for identifying suitable MSD levels. In one embodiment, an entropy measure is used and in the other embodiment, fractal dimension is used.

### BACKGROUND

Process industries may use large conglomerations of interconnected sub-systems to control complex processes. Fault monitoring and diagnosis is necessary to identify faults at an incipient state to prevent failures and reduce downtime. Different approaches have been explored for this purpose.

In one approach, on-line sensor data is transmitted to a base station that performs analysis and indicates the state of a process control system. The sensor data may be analyzed to obtain diagnosis and decisions at a sub-system/unit level, while also taking into consideration the effect of related units.

Wavelet technology is increasingly used for fault analysis and fault monitoring, trend identification, feature extraction and signal understanding. Multi-resolution analysis (MRA) provides varying levels of resolution for signals based on the assumption that different signals are better represented by different levels of resolution. A fault that is not recognized at one resolution may be identified at another resolution. In addition, wavelet transforms provide the capability for compact representation of signals, opening a path for signal/image/data compression.

Wavelet coefficients of a signal depend on two factors. First, the transform that is utilized, and second, the level of decompositions (Multi-resolution Signal Decomposition, MSD) to which the signal is decomposed. These two factors are correlated. If the transform cannot remove considerable high frequency components in the approximate coefficients, there is a requirement of larger number of decomposition levels to be used to get a reasonably smoothed signal output. The number of MSD levels can change with respect to a signal window, noise incorporated in the signal with time, and other factors. The levels may change frequently for real time applications, making it difficult to find suitable MSD levels for wavelet decomposition.

### SUMMARY

Multi-resolution Signal Decomposition (MSD) levels for wavelet decomposition are determined automatically in real time. Local high frequency variations are eliminated, while retaining gradual patterns present in process control data for identifying progressive faults. High frequency variations may become important for any sudden faults.

In one embodiment, a denoising effect of wavelet transforms that eliminate local high frequency variations and retain gradual patterns present in the data in the form of approximate coefficients is used. Entropy measures of these approximate coefficients are calculated, and the rate of change of entropy between original and first level of decomposition is projected onto an MSD axis, providing the number of optimum levels.

In a further embodiment, the denoising effect of wavelet transforms shown in the approximate coefficients is used with fractal dimension to quantify the irregularity present in the data. Fractal dimension of the wavelet-decomposed signal reduce to an integer value as local high frequency variations are eliminated and the signal is smoothed out. Fractal dimension in this context serves as a measure of roughness present in the signal.

### BRIEF DESCRIPTION OF THE DRAWINGS

FIG. 1 is a block flow diagram illustrating multiple levels of decomposition using various wavelet analysis filters according to an example embodiment.

FIG. 2 is a block flow diagram illustrating wavelet decomposition and reconstruction according to an example embodiment.

FIG. 3 is a flow chart illustrating identification of a suitable decomposition level according to an example embodiment.

FIG. 4 illustrates fractal dimensions for regular and irregular objects according to an example embodiment.

FIG. 5 is a flow chart illustrating the use of fractal dimension for finding suitable multi-resolution decomposition levels.

FIG. 6 is a flow chart illustrating the use of entropy for finding suitable multi-resolution decomposition levels.

FIG. 7 is a block diagram of a computer system for performing methods according to an example embodiment.

### DETAILED DESCRIPTION

In the following description, reference is made to the accompanying drawings that form a part hereof, and in which is shown by way of illustration specific embodiments, which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

Multi-resolution Signal Decomposition (MSD) levels for wavelet decomposition are determined automatically in real time. Local high frequency variations can be eliminated or processed, in addition to retaining gradual patterns present in process control data. A first embodiment is described that utilizes an entropy measure, and a second embodiment uses fractal dimension, which describe the irregularity in the signal at different levels of decomposition. Nearly suitable MSD levels for wavelet decomposition are found automatically by utilizing these measures. The number of MSD levels plays an important role, as high MSD levels need not necessarily give additional information, and in some cases, the information deteriorates at too high a level. In real-time situations, there is no predetermined optimal level, and manual identification is not timely.

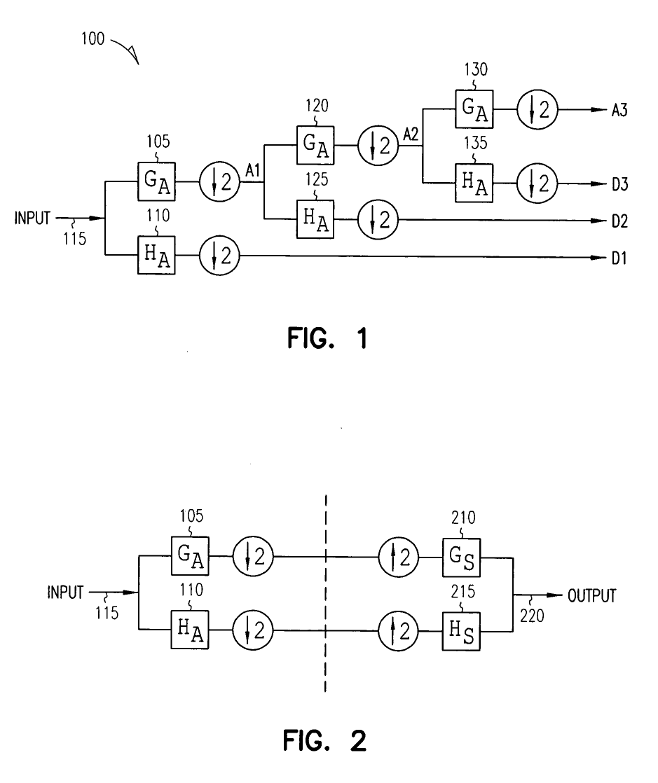

FIG. 1 is a block flow diagram illustrating multiple levels of decomposition indicated generally at 100, using various wavelet analysis filters. G_{A} at 105 and H_{A} at 110 are analysis filters that receive an input signal 115 and decompose the signal. These filters comprise a first level of decomposition, resulting in a “D1” signal from H_{A} filter 110 and an “A1” signal from G_{A} filter 105. In one embodiment, the filters comprise a HPF (high pass filter) and LPF (low pass filter) wavelet filter bank. The “A1” signal is provided to a second level of decomposition using the filters G_{A} and H_{A} indicated at 120 and 125 respectively. “A2” and “D2” signals are output from this second level. The A2 signal is fed to a third level of decomposition using the G_{A} and H_{A} filters 130 and 135, having outputs “A3” and “D3” respectively. Further levels may be provided in a similar manner.

The wavelet transform at each MSD level provides two sets of transformed coefficients. One is an approximated set, “A”, and the second is a detailed coefficient set “D”. At each level, the approximation coefficient set is further subjected to wavelet decomposition, which gives another set of approximate and detailed coefficients at different resolution. In this process, with an increasing number of MSD levels, the wavelet approximate signal used for further decompositions smoothes out. At every additional level of MSD, any high frequency components present in the signal are removed. Once the signal does not have prominent high frequency components that can be addressed by the wavelet transform, further MSD levels will not add value to the existing information.

FIG. 2 is a block flow diagram illustrating wavelet decomposition and reconstruction according to an example embodiment. G_{S} 210 and H_{S} 215 are synthesis filters that reconstruct the decomposed signal from G_{A} 105 and H_{A} 110 to provide an output signal at 220. In further embodiments, the filters, G_{A} 105 and H_{A} 110 may be the same as those in FIG. 1, or different, and the decomposed signal may be provided from one of the different levels indicated in FIG. 1.

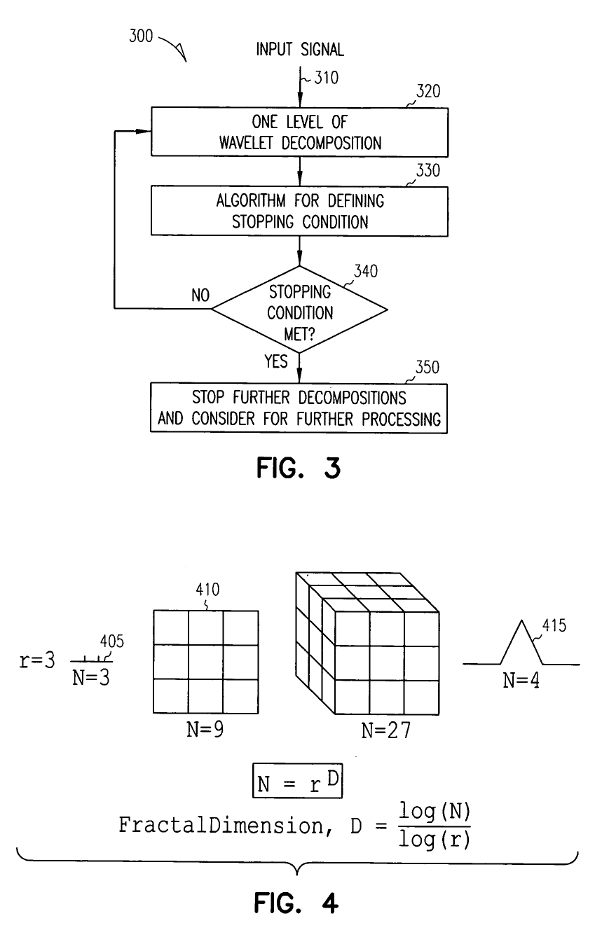

FIG. 3 is a flow chart 300 illustrating identification of a suitable decomposition level according to an example embodiment. An input signal at 310 is provided to a wavelet decomposition algorithm at 320, which provides one level of wavelet decomposition. In one embodiment, a Daubechies wavelet decomposition transform is used, but other different types of transforms may be used. The approximate wavelet coefficients of that level are provided to an algorithm for defining a stopping condition at 330. In one embodiment, the stopping condition is a measure of the input signal irregularity. The approximation coefficients are tested with a defined criterion. If the criterion is met, as indicated at stopping condition met conditional block 340, further decomposition is stopped and the wavelet coefficients thus computed are considered for further processing at 350. If the stopping condition/criterion is not met at 340, a next level of decomposition coefficients is determined at 320, and the process is continued until the stopping condition is met.

In one embodiment, the stopping condition is a function of fractal dimension of the approximated signal at each level. Fractal geometry possesses properties to suitable model and represents shapes and phenomena better than Euclidian geometry. The underlying characteristic of a fractal is that an iterative process, starting from an initial tile, generates it. A formal definition of the fractal is based on this property, and it is any shape where parts, when magnified, reveal as much detail as the whole. This quality is called self-similarity, which is a major contributor to the definition of Fractal Dimension, which also indirectly describes the dimension of the shape.

For a geometric object like a point, in FIG. 4, line 405, or plane 410, fractal dimensions are zero, one and two respectively. If an object residing in Euclidean dimension D is reduced in linear size by 1/r in each direction, its measure (length, area, or volume) would increase to N=r^{D} times the original as depicted in FIG. 4, where the fractal dimension, D=log(N)/log(r). D=1 for a straight line. For a fractal, FD can be a fraction. Object 415 is a fractal, whose FD=1.26, as there are four lines with length ⅓. The two lines forming a cone structure in object 415 can be considered as a deviation from the base structure, which is a line.

In one embodiment, fractal dimension is calculated. This can be done using any approach but for demonstration, a standard box-counting method is used to calculate the fractal dimension. In this method, the object under consideration is enclosed in boxes. Box sizes, varying from 200 to 8 units are tested for various signals and most suitable box sizes were found. One unit of the box is equal to one input signal sample. FD is calculated with these box sizes and slope of the best-fit line for log(N) vs log(r) is considered as the calculated FD.

The fractal dimension can give a pointer to the information content present in the signal. It can indirectly help in reflecting the irregularity present in the signal at every level of decomposition. In one embodiment, the stopping condition 340 is met once the fractal dimension of the wavelet coefficients at that particular MSD level is approximately equal to one. This condition is used for dealing with single dimension signals. If the inputs are in 2D, this condition value will become two. Further decomposition levels than this stopping condition do not yield considerable gain in analysis, and in some cases may even reduce it. It is known that approximate signals can map to an inherent pattern or trend in the input signal. It was observed that this trend may not follow the input signal if the decomposition levels are more than that defined by the stopping condition. As approximate coefficients are used for further decomposition levels, once it is clearly smoothed out, there may be no gain in further smoothing it when considered for further processing. As after each MSD, the signal smoothens out, FD reduces when compared to that at a lower level.

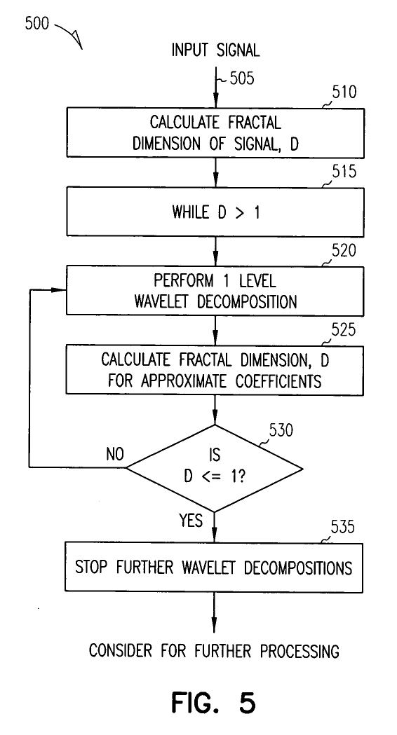

FIG. 5 is a flow chart illustrating the use of fractal dimension for finding suitable multi-resolution decomposition levels generally at 500. An input signal is received at 505 and the fractal dimension, D, is calculated at 510. While D is greater than one at 515, one level of wavelet decomposition is performed at 520 and the fractal dimension, D, for the approximate coefficients are calculated at 525. The reason for this condition is that the signal is one dimensional with irregularities present. Hence the fractal dimension always will be more than one. If D is not less than or equal to 1, blocks 520 and 525 are repeated. If D is less than or equal to one, further wavelet decomposition is stopped at 535, and these coefficients are subjected to further processing, for example, in case of compression, entropy coding of wavelet coefficients at the current level is performed. The method looks for information content in the signal in the form of irregularity for MSD level determination.

To apply this method to a real time scenario, it may be implemented in batch mode, wherein windowed sets of sensor values are considered for an application, for example, like compression. Window size can be calculated based on the wavelet filters and the computational complexity. The number may be arrived at by weighing the computation complexity involved in calculating the fractal dimension at every level and the real-time/on-line time schedule and the resources of an application. Thus, the window size may be calculated as a one-time operation.

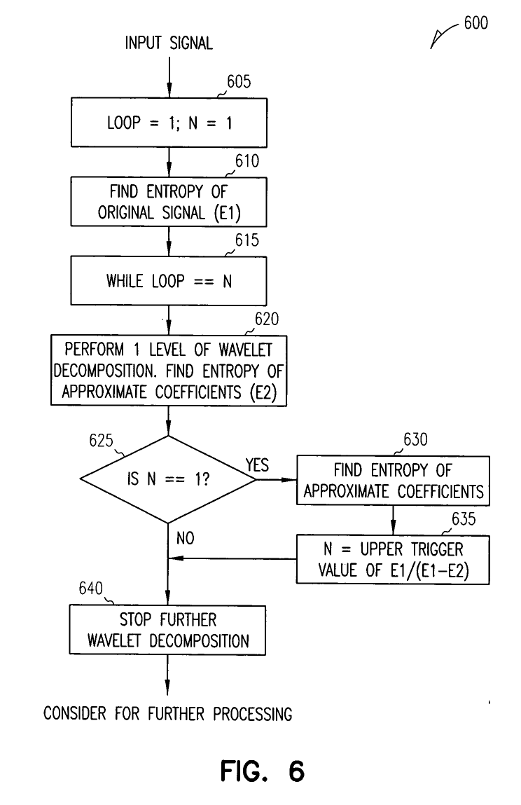

FIG. 6 is a flow chart 600 illustrating a method of using entropy for finding suitable multi-resolution decomposition levels. The method automatically determines nearly optimum MSD levels for signals, based on the information content (entropy) of the original signal and approximate coefficients after the first level of decomposition. The advantage of this method is that one need not perform wavelet decompositions explicitly to come out with the near optimum or suitable wavelet decomposition level. As entropy relates to the information content present in the signal, it can indirectly help in reflecting the irregularity present in the signal, which is addressed by decomposing the signal at every level. The projection of rate of change of entropy (from the original signal) gives the number of nearly optimum MSD levels. This projection gives nearly the minimum of the entropy curve when considered as a polynomial, beyond which further iteration may not lead to considerable gain in further analysis, and in some cases may even reduce it.

At 605, an input signal is received, and a reference variable value, Loop, and decomposition level, N, are initialized to one. The entropy of the original signal, E1, is found at 610. While Loop is equal to N at 615, one level of wavelet decomposition is performed at 620, and the entropy of approximate coefficients, E2, is found. If N==1 at 625, block 630 finds the entropy of approximation coefficients. At 635, N is set to the upper integer value of E1/(E1−E2). Eg.: If E1/(E1−E2) is 2.58, then the number of decomposition levels identified in N is 3, and further wavelet decompositions are stopped at 640.

At 615, if Loop is not equal to N, further wavelet decomposition is stopped at 640, and these coefficients are subjected to further processing.

This method does not depend on a threshold, but looks out for the near minimum of the entropy polynomial curve without actually finding out all the points in the curve at different MSD levels.

The number of MSD levels is determined even before the actual decompositions are done. In situations where there are very stringent time and memory constraints, the method can be beneficial in giving the number of MSD levels very quickly. Based on resource availability and theoretical calculation of complexity, a lesser number of levels may be used, even with some compromise on the analysis.

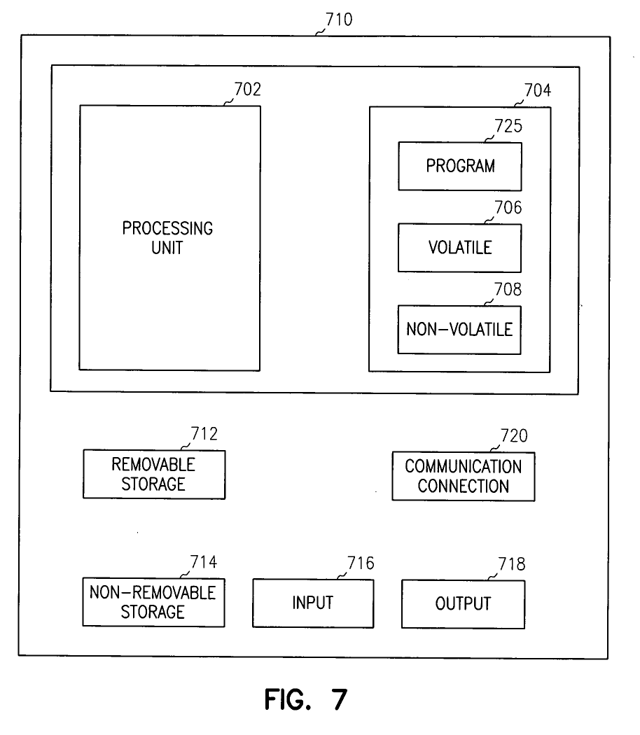

A block diagram of a computer system that executes programming for performing the above methods is shown in FIG. 7. All components may not be needed for various implementations, such as in remote units. The computer system may be implemented on a chip, or as a computer system, such as a personal computer, or part of a larger computer system or process controller. A general computing device in the form of a computer 710, may include a processing unit 702, memory 704, removable storage 712, and non-removable storage 714. Memory 704 may include volatile memory 706 and non-volatile memory 708. Computer 710 may include—or have access to a computing environment that includes—a variety of computer-readable media, such as volatile memory 706 and non-volatile memory 708, removable storage 712 and non-removable storage 714. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 710 may include or have access to a computing environment that includes input 716, output 718, and a communication connection 720. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 702 of the computer 710. A hard drive, CD-ROM, and RAM are some examples of articles including a computer-readable medium. For example, a computer program 725 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer system 700 to provide generic access controls in a COM based computer network system having multiple users and servers.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method of determining a suitable decomposition level of a wavelet transform, the method comprising:
performing a first level of wavelet multi-resolution signal decomposition on an input signal;
determining signal irregularity as a function of signal characterizing properties
determining if a stopping condition has been met as a function of the signal characterizing properties; and
repeating decomposition to more levels until the stopping condition has been met.

2. The method of claim 1 wherein the signal irregularity is a function of a fractal dimension of signal decomposition coefficients.

3. The method of claim 1 wherein the signal irregularity is a function of fractal dimension of an approximated signal at each level.

4. The method of claim 3 and further comprising using a box-counting method to calculate the fractal dimension.

5. The method of claim 4 wherein a slope of a best fit line is used for determining the fractal dimension.

6. The method of claim 2 wherein the stopping condition corresponds to a fractal dimension of less than or equal to one in case of 1-Dimensional signals.

7. The method of claim 2 wherein the stopping condition corresponds to a fractal dimension of less than or equal to one in case of 2-Dimensional signals, leading to the condition that in case of N dimensional signal, the stopping condition corresponds to a fractal dimension of less than or equal to N.

8. The method of claim 1 wherein the signal irregularity is a function of entropy of the input signal.

9. The method of claim 8 wherein the signal irregularity is a further function of approximate coefficients after a first level of decomposition.

10. The method of claim 1 and further comprising further analysis of wavelet coefficients after the stopping condition has been met.

11. The method of claim 1 wherein the input signal corresponds to sensor signals in a process control system.

12. A computer readable medium having instructions stored thereon for causing a computer to perform a method of determining a decomposition level for a wavelet transform, the method comprising:
performing a level of wavelet multi-resolution signal decomposition on an input signal;
determining signal irregularity;
determining if a stopping condition has been met as a function of the signal irregularity; and
repeating decomposition at more levels until the stopping condition has been met.

13. The computer readable medium of claim 12 wherein the signal irregularity is a function of a fractal dimension of signal decomposition coefficients.

14. The computer readable medium of claim 12 wherein the signal irregularity is a function of fractal dimension of an approximated signal at each level.

15. The computer readable medium of claim 12 wherein the stopping condition corresponds to a fractal dimension of less than or equal to one in case of 1-Dimensional signals.

16. The computer readable medium of claim 12 wherein the stopping condition corresponds to a fractal dimension of less than or equal to one in case of 2-Dimensional signals, leading to the condition that in case of N dimensional signal, the stopping condition corresponds to a fractal dimension of less than or equal to N.

17. The computer readable medium of claim 12 wherein the signal irregularity is a function of entropy of the input signal.

18. The computer readable medium of claim 17 wherein the signal irregularity is a further function of approximate coefficients after a first level of decomposition.

19. The computer readable medium of claim 12 and further comprising entropy coding of wavelet coefficients after the stopping condition has been met.

20. The computer readable medium of claim 12 wherein the input signal corresponds to sensor signals in a process control system.

21. A process control system comprising:
means for performing a level of wavelet multi-resolution signal decomposition on an input signal;
means for determining signal irregularity;
means for determining if a stopping condition has been met as a function of the signal irregularity; and
means for repeating decomposition at more levels until the stopping condition has been met.

22. A method of wavelet transform comprising:
performing a first level wavelet decomposition by filtering an input signal through a HPF and LPF wavelet filter bank to capture first level output coefficients;
determining irregularity characteristics of the LPF output coefficient based on signal characterizing properties pertaining to said LPF output coefficient; and
determining the necessity of further wavelet decomposition after the first level decomposition based on said irregularity measures.

23. The method of claim 22 wherein said properties are selected from the group consisting of fractal dimension and entropy of said LPF output coefficients.
